(19) United States
(12) Patent Application Publication
(10) Pub. No.: US 2014/0160724 A1
(43) Pub. Date: Jun. 12, 2014

(54) Fabrication of Light-Emitting Devices

(71) Applicant: QUARKSTAR LLC, LAS VEGAS, NV (US)

(72) Inventor: Louis Lerman, Las Vegas, NV (US)

(73) Assignee: QUARKSTAR LLC, LAS VEGAS, NV (US)

(21) Appl. No.: 14/177,961

(22) Filed: Feb. 11, 2014

Related U.S. Application Data
(60) Provisional application No. 61/780,537, filed on Mar. 13, 2013.

(51) Int. Cl. F21V 5/00; F21V 13/04; F21V 13/02

(52) U.S. Cl. CPC F21V 5/008; F21V 13/02; F21V 13/04
USPC 362/84; 362/311.06; 362/308; 156/60; 156/275.5

(57) ABSTRACT

Light-emitting devices that include a scattering element of arbitrary shape and processes for fabrication thereof are described. In one aspect a method for forming a light-emitting device includes providing a light-emitting element (LEE) on a base surface of a base substrate; coupling a first optical element with the base surface of the base substrate, where the first optical element has a first surface facing the LEE and a second surface opposing the first surface; disposing the first optical element in a curable or settable fluid so that the fluid conforms to the second surface; and curing or setting the fluid to form a second optical element including a molded transparent layer adjacent the second surface of the first optical element.

### CROSS-REFERENCE TO RELATED APPLICATION

This application claims the benefit under 35 U.S.C. §119(e)(1) of U.S. Provisional Application No. 61/780,537, filed on Mar. 13, 2013, which is incorporated by reference herein.

### TECHNICAL FIELD

The described technology relates to fabrication of light-emitting devices, for example fabrication of light-emitting devices that include a scattering element of arbitrary shape.

### BACKGROUND

The present technology relates generally to light-emitting devices and, in particular, to light-emitting devices that feature a solid state light-emitting element and a scattering element and an extractor element remote from a light-emitting element.

Light-emitting elements are ubiquitous in the modern world, being used in applications ranging from general illumination (e.g., light bulbs) to lighting electronic information displays (e.g., backlights and front-lights for LCDs) to medical devices and therapeutics. Solid state light emitting devices, which include light emitting diodes (LEDs), are increasingly being adopted in a variety of fields, promising low power consumption, high luminous efficacy and longevity, particularly in comparison to incandescent and other conventional light sources.

One example of a SSL device increasingly being used for in luminaires is a so-called “white LED.” Conventional white LEDs typically include an LED that emits blue or ultraviolet light and a phosphor or other luminescent material. The device generates white light via down-conversion of blue or UV light from the LED (referred to as “pump light”) by the phosphor. Such devices are also referred to as phosphor-based LEDs (PLEDs). Although subject to losses due to light-conversion, various aspects of PLEDs promise reduced complexity, better cost efficiency and durability of PLED-based luminaires in comparison to other types of luminaires.

While new types of phosphors are being actively investigated and developed, configuration of PLED-based light-emitting devices, however, provides further challenges due to the properties of available luminescent materials. Challenges include light-energy losses from photon conversion, phosphor self-heating from Stokes loss, dependence of photon conversion properties on operating temperature, degradation due to permanent changes of the chemical and physical composition of phosphors in effect of overheating or other damage, dependence of the conversion properties on intensity of light, propagation of light in undesired directions in effect of the random emission of converted light that is emitted from the phosphor, undesired chemical properties of phosphors, and controlled deposition of phosphors in light-emitting devices, for example.

### SUMMARY

The described technology relates to fabrication of light-emitting devices, for example fabrication of light-emitting devices that include a scattering element of arbitrary shape.

In one aspect, a light-emitting device includes a base substrate that has a base surface; a light-emitting element (LEE) that is configured to emit light, where the LEE is disposed on the base surface; a first optical element having a first surface that is spaced apart from the LEE and positioned to receive light from the LEE, where the first optical element includes scattering centers that are arranged to scatter light from the LEE, and where the first optical element has a non-hemispherical shape; a second optical element that has an exit surface, where the second optical element is transparent and in contact with the first optical element, there being an optical interface between the first and second optical elements at the place of contact, where the optical interface is opposite the first surface of the first optical element, and where the second optical element is arranged to receive at least a portion of the light through the optical interface; and a transparent shell that has an inner surface and an opposing outer surface, where the inner surface is in contact with the exit surface of the second optical element, where: a medium adjacent to the first surface of the first optical element has a refractive index n₀, the first optical element includes a material that has a refractive index n₁, where n₀<n₁, the second optical element includes a material that has a refractive index n₂, where n₀<n₂, and the transparent shell includes a material that has a refractive index n₃, where n₃≧n₂.

The foregoing and other embodiments can each optionally include one or more of the following features, alone or in combination. In some embodiments, the first optical element includes phosphor. In some embodiments, a hardness of the transparent shell can be larger than a hardness of the second optical element. In some embodiments, the material of the transparent shell can be solid and the material of the second optical element can be liquid or gel. In some embodiments, the light-emitting device can further include a reflective layer disposed on the base surface of the base substrate. In some embodiments, the outer surface of the transparent shell can be a transparent surface that is shaped such that an angle of incidence on the outer surface of the light provided by the first optical element that directly impinges on the outer surface is less than a critical angle for total internal reflection. In some embodiments, the outer surface of the transparent shell can be a transparent surface that is shaped such that an angle of incidence on the outer surface of the light provided by the first optical element that directly impinges on the outer surface is less than a Brewster angle.

In another aspect, a method for forming a light-emitting device includes providing a light-emitting element (LEE) on a base surface of a base substrate; coupling a first optical element with the base surface of the base substrate, where the first optical element has a first surface facing the LEE and a second surface opposing the first surface, the first surface is spaced apart from the LEE, the first optical element includes a material that has a first refractive index n₁, and where a medium adjacent to the first surface of the first optical element has a refractive index n₀<n₁; disposing the first optical element in a curable or settable fluid so that the fluid conforms to the second surface; and curing or setting the fluid to form a second optical element adjacent the second surface of the first optical element, where the second optical element has a refractive index n₂>n₀.

The foregoing and other embodiments can each optionally include one or more of the following features, alone or in combination. In some embodiments the second optical element includes a molded transparent layer. In some embodiments, the second surface of the first optical element has a non-hemispherical shape. In some embodiments, the fluid is provided in a transparent shell. In some embodiments, the transparent shell has an outer surface that corresponds to the exit surface of the second optical element. In some embodiments, the transparent shell remains with the light-emitting device and an outer surface of the transparent shell can be a transparent surface that is shaped such that an angle of incidence on the outer surface of the light provided by the second optical element that directly impinges on the outer surface is less than a critical angle for total internal reflection.

In some embodiments, the curing or setting includes exposing the fluid to UV radiation. In some embodiments, the curing or setting includes heating the fluid. In some embodiments, the method further includes providing a reflective layer on the base surface, where the reflective layer can be configured to diffusely or specularly reflect light. In some embodiments, the exit surface of the second optical element can be a transparent surface that is shaped such that an angle of incidence on the exit surface of the light provided by the first optical element that directly impinges on the exit surface is less than a critical angle for total internal reflection. In some embodiments, the exit surface of the second optical element can be a transparent surface that is shaped such that an angle of incidence on the exit surface of the light provided by the first optical element that directly impinges on the exit surface is less than a Brewster angle.

### BRIEF DESCRIPTION OF THE DRAWINGS

FIG. 1 shows a cross-sectional view of an example of a light-emitting device.

FIGS. 2A-2E show aspects of an example of a fabrication process of light-emitting devices.

Like reference symbols in the various drawings indicate like elements.

### DETAILED DESCRIPTION

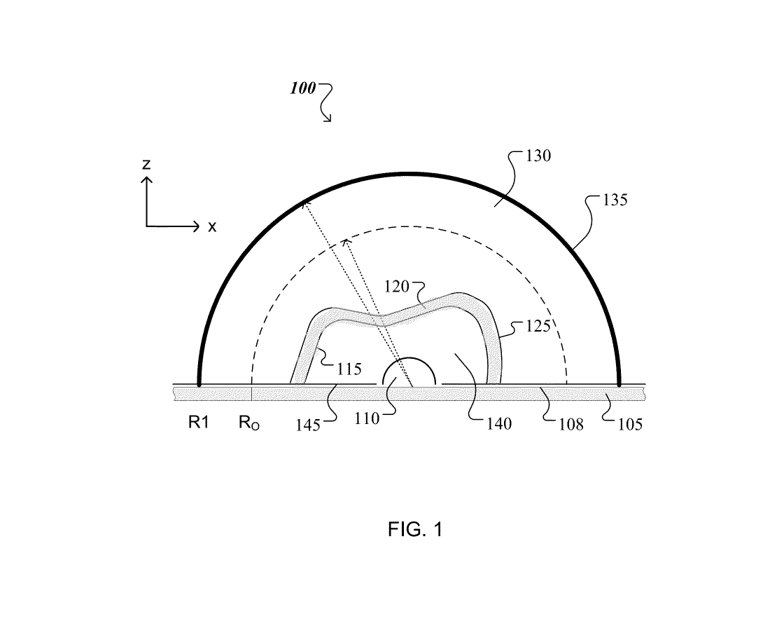

FIG. 1 shows a cross-sectional side view of a light-emitting device 100. The light-emitting device 100 can include a base substrate 105, one or more light-emitting elements, such as light-emitting element 110 (e.g., a blue pump LED), a scattering element 120, and an extractor element 130. The scattering element 120 is arranged on the base substrate 105 and is shaped to at least partially surround the light-emitting element 110 in an enclosure 140. An index of refraction n₀ of a medium inside the enclosure 140 is smaller than an index of refraction nₚ of the scattering element 120. An index of refraction of the scattering element 120 can be smaller than or equal to an index of refraction of the extractor element 130. Such a choice of relative values for the indexes of refraction n₀<nₚ≦n₁ enables asymmetric propagation of light emitted by the light-emitting element 110 through the light-emitting device 100. In the example illustrated in FIG. 1, the scattering element 120 is located on the inside of the extractor element 130 adjacent the enclosure 140 of the extractor element 130 to form an optical interface 125.

The shape of the optical interface 125 between the scattering element 120 and the extractor element 130 can affect the distribution of light output by the light-emitting device 100. For example, an optical interface 125 shaped as an oblate dome (having a dome height shorter than a base diameter) provides an intensity distribution biased along the optical axis of the light-emitting device 100, e.g., the +z axis. As another example, an optical interface 125 shaped as an oblong dome (having a dome height longer than a base diameter) provides a laterally-biased intensity distribution (biased away from the optical axis of the light-emitting device 100.) In general, when fabricating light-emitting devices, the shape of the optical interface between the scattering element and extractor element can be limited by available machining processes. The fabrication processes described in detail below provide the capability to produce light-emitting devices having a variety of shapes of the optical interfaces between the scattering element and extractor element not readily producible by conventional fabrication processes.

In some implementations, the scattering element 120 can have an irregular shape (as illustrated). Furthermore, the scattering element 120 can have a uniform or non-uniform geometrical or effective thickness, generally referred to as thickness and as the case may be referring to a geometrical or effective thickness as appropriate. The effective thickness refers to a combination of geometrical thickness and scattering/conversion properties of the scattering element 120. Depending on the embodiment, a regular or irregular shaped scattering element 120 may have a regular or irregular thickness. The scattering element 120 includes a plurality of scattering centers configured to scatter light. Depending on the embodiment, the scattering centers can be configured to elastically, inelastically, or elastically and inelastically scatter light.

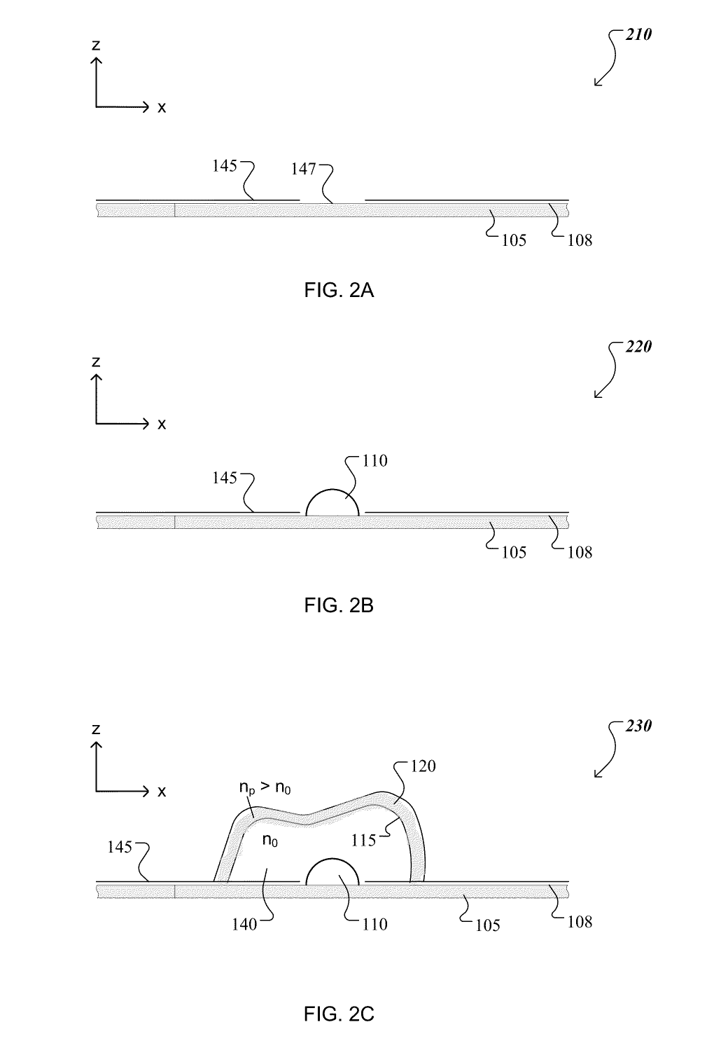

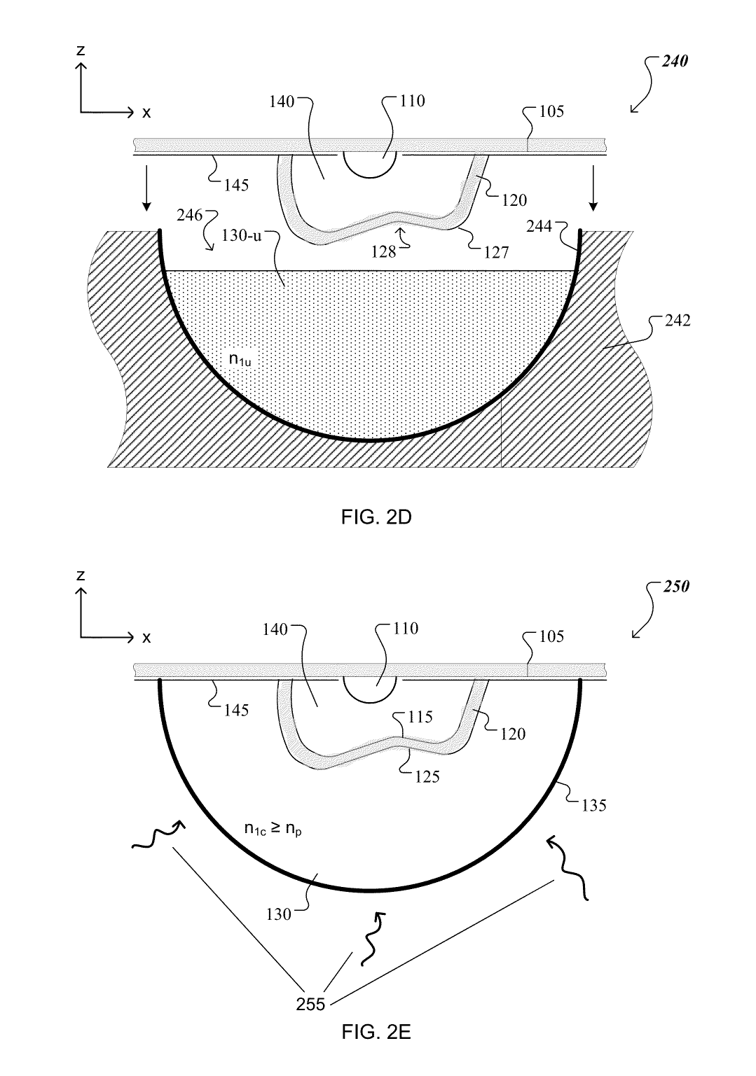

In some implementations, the light-emitting elements can be pre-packaged LEDs, for example LED dies encapsulated in silicone. A size of encapsulated LEDs can be 1, 3 or 5 mm in diameter. The base substrate 105 has a surface 108 on which the light-emitting element 110 can be disposed. The surface 108 of the base substrate 105 can be reflective (e.g., a mirror). In some implementations, a reflective layer 145 can be deposited on the surface 108 of the base substrate 105, as described below in connection with FIG. 2A. The reflective layer 145 can be a metal mirror (e.g., Ag, Al), a dielectric mirror, a non-absorbing diffuser, or any combination thereof.

At least a portion of light emitted by the light-emitting element 110, or back-scattered by the scattering element 120, can be reflected by the surface 108 (or the reflective layer 145). The scattering element 120 can include active scattering centers, e.g., phosphors configured to inelastically scatter pump (e.g., blue) light emitted by the light-emitting element 110 to inelastically scattered light (green, yellow, etc.). The scattering element 120 can include passive scattering centers configured to elastically scatter the pump light, without changing its color. The scattering element 120 has a first surface 115 spaced apart from the light-emitting element 110 and positioned to receive the light from the light-emitting element 110. In some implementations, the scattering element 120 has uniform thickness. The thickness of the scattering element 120 can be 0.02, 0.20, 0.50, or 1 mm, for example. In general, the first surface 115 of the scattering element 120 can have a desired shape, e.g., spherical, parabolic, elliptical, or an arbitrary, mostly concave (with respect to the enclosure 140) shape, as illustrated in FIG. 1.

The light-emitting element 110 is disposed on the surface 108 of the base substrate 105, in an opening/enclosure 140 that is, at least in part, defined by the first surface 115. The enclosure 140 is referred to as a recovery enclosure, as described below. In some implementations, the reflective layer 145 disposed on the surface 108 of the base substrate 105 extends to at least the first surface 115 of the scattering element 120. In other implementations, the reflective layer 145 extends to at least an exit surface 135 of the extractor element 130. In some implementations, the reflective layer 145 extends beyond the exit surface 135 of the extractor element 130. The enclosure 140 can be filled with a medium (e.g., gas or air) and encloses the light-emitting element 110, and at least a portion of the reflective layer 145.

In general, the shape of exit surface 135 can vary as desired, e.g., spherical or cylindrical (as shown in FIG. 1), parabolic, elliptical, etc., with or without facets/steps. In the example illustrated in FIG. 1, the exit surface 135 of the extractor element 130 has a radius R₁ that is concentric with a notional surface of radius Rₒ located within the extractor element 130, such that the notional surface contains the optical interface 125 between the scattering element 120 and the extractor element 130. In some implementations, the extractor element 130 satisfies a Weierstrass configuration R₁≧R_{1W}, such that an angle of incidence on the exit surface 135 of the scattered light that directly impinges on the exit surface 135 is less than a critical angle. In this manner, the scattered light that directly impinges on the exit surface 135 experiences little or no total internal reflection thereon. The Weierstrass radius is given by R_{1W}=R_{O}·n₁, where R_{O} is the radius of the notional surface that encloses at least the scattering element 120 of the light-emitting device 100, and n₁ denotes the index of refraction of the material of the extractor element 130. In some implementations, the extractor element 130 satisfies a Brewster configuration R₁≧R_{1B}, such that an angle of incidence on the exit surface 135 of the scattered light that directly impinges on the exit surface 135 is less than the Brewster angle. In this case, the scattered light that directly impinges on the exit surface 135 experiences even less total internal reflection thereon than in the Weierstrass configuration. The Brewster radius is given by R_{1B}=R_{O}(1+n1²)^{+1/2}, where R_{O} is the radius of the notional surface that encloses at least the scattering element 120 of the light-emitting device 100, and n₁ denotes the index of refraction of the material of the extractor element 130. The Brewster radius R_{1B} is larger than the Weierstrass radius R_{1W}, R_{1B}>R_{1W}. Moreover, further increasing the radius R₁ of the extractor element 130 beyond the Brewster radius R_{1B} renders reduction in Fresnel reflections that plateaus off. Therefore, the Brewster radius R_{1B} can be used as an upper bound for the radius R₁ of the extractor element 130.

In this example, light propagation asymmetry arises from the relative values of the indexes of refraction of materials in the enclosure 140 (index n₀), in the scattering element 120 (index nₚ), and in the extractor element 130 (index n₁). For instance, if nₚ=1.5 and n₀=1.0, that is n₀<nₚ, a large fraction (˜75%) of the isotropically distributed photons impinging on the first surface 115 will be reflected by total internal reflection (TIR) back into the scattering element 120 and only a smaller fraction (˜25%) will be transmitted backwards into the recovery enclosure 140 from where only few may reach the light-emitting element 110. At the optical interface 125, the condition nₚ≦n₁ will guarantee that substantially all photons reaching the optical interface 125 will transition into the extractor element 130, and the Brewster condition will further guarantee that practically all these photons will transmit into air without TIR through the exit surface 135. Only a small fraction (down to about ˜4% depending on incidence angle) will be returned by Fresnel reflection at the exit surface 135. For the above examples, when the radius R_{O} of the notional surface enclosing the scattering element 120 is 3 mm, the Weierstrass radius R_{1W}=4.50 mm, and the Brewster radius R_{1B}=5.41 mm.

In some implementations, the scattering element 120 can be pre-formed in a desired shape. For example, scattering elements can be fabricated (e.g., molded) separately and procured/provided as pre-formed components. As noted above, the shape of an optical interface 125 between the scattering element 120 and the extractor element 130 can influence the illumination pattern output by the light-emitting device 100. Accordingly, it is desirable to form (e.g., mold) the extractor element 130 to correspond to a desired shape of the outer surface of the scattering element 120.

FIGS. 2A-E show an example of a fabrication process of a light-emitting device, such as light-emitting device 100 described herein. Cartesian coordinates are provided for reference.

At 210, a base substrate 105 having a surface 108 is provided, as shown in FIG. 2A. Substrate 105 extends in the x-y plane and has a relatively short z-dimension. A reflective layer 145 (e.g., a layer formed from a specular and/or diffuse reflective material, such as aluminum or silver) is disposed on surface 108. The reflective layer 145 includes a gap 147 to accommodate a light-emitting element 110.

At 220, the light-emitting element 110 is disposed on the base substrate 105 in gap 147, as shown in FIG. 2B. Generally, a variety of light-emitting elements can be used, such as, for example, packaged light-emitting elements (e.g., an LED die encapsulated in silicone).

At 230, a scattering element 120 (e.g., a phosphor-containing composite) is secured to base substrate 105, as shown in FIG. 2C. In some implementations, the scattering element 120 can be secured to the base substrate 105 using an adhesive, such as a silicone adhesive. As described above in connection with FIG. 1, the scattering element 120 can be pre-formed in a variety of shapes. The scattering element 120 encloses the light-emitting element 110, such that a first surface 115 is spaced apart from the light-emitting element 110, creating an enclosure 140. The refractive index n₀ of the medium within the enclosure 140 (e.g., air) is smaller than the refractive index nₚ of the scattering element 120.

At 240, an extractor element is formed to accommodate a shape of the outer surface 127 of the scattering element 120, as shown in FIG. 2D. The base substrate 105 with the light-emitting element 110 and the scattering element 120 is positioned over a mold 242 having a cavity 246 having a size and shape corresponding to the desired shape of the extractor element's exit surface. Cavity 246 is filled with a curable or settable fluid 130-u (e.g., uncured silicone, liquid high index glass, epoxy, gel, etc.). The scattering element 120 is placed in a desired position with respect to the cavity 246, for example, an optical axis of the light-emitting element 110 can be aligned with the center axis of the cavity 246.

In some implementations, the cavity 246 (i) is sized to contain a notional surface of radius R_{O} (not shown in FIG. 2D), such that the notional surface inscribes the scattering element 120, and (ii) has a radius of curvature R₁ that satisfies the Weierstrass condition, R₁≧R_{O}/n_{1c}, as described above in connection with FIG. 1. In some implementations, the radius of curvature R₁ of the notional surface that inscribes the scattering element 120 satisfies the Brewster condition, R₁≧R_{O}(1+n_{1c}²)^{1/2}, as described above in connection with FIG. 1.

The fill level of the fluid 130-u in the cavity 246 can be configured such that an unfilled volume enclosed by the cavity 246 is slightly less (e.g., 2%, 5%, 10% less) than a volume enclosed by an outer surface 127 of the scattering element 120.

In some implementations, a hard optical-quality surface 244 (e.g., having a surface polished to a 0.01, 0.1, 1 of a wavelength) is disposed in the cavity 246 before it is filled with the fluid 130-u. In this case, the hard optical-quality surface remains integrated with the extractor element 130 after the curing operation performed at 250. The mold 242 can include one or more channels (not shown) to dispose of excess fluid displaced at 240 when forming the extractor.

In some implementations, the hard optical-quality surface can be configured to provide a shell for the uncured fluid 130-u. Such a shell can be configured to be held in place by the mold 242 as illustrated in FIG. 2D or other support (not illustrated). For example, such other support can be configured to support the shell in one or more point-like locations.

The base substrate 105 is brought against the mold 242 such that the scattering element 120 is immersed in the fluid 130-u. The base substrate 105 and the mold 242 can be brought together in a motion in the Z-direction as indicated by the arrows shown in FIG. 2D. In some implementations, the base substrate 105 and the mold 242 can be brought together in a manner that provides an opening to displace air from the cavity 246 between a top surface of the fluid 130-u and the scattering element 120 (e.g., due to the shape of region 128 of the scattering element 120) to avoid formation of voids, for example via trapping air bubbles between surface 127 or 145 and fluid 130-u. For example, the base substrate 105 can be rocked back-and-forth about an axis parallel to the y-axis, while the scattering element 120 advances into the fluid 130-u in a direction antiparallel to the z-axis. The mold 242 and the base substrate 105 are pressed together to force the fluid 130-u to fill all voids. In some implementations, a vacuum source can be used to extract excess air.

At 250, the fluid 130-u that forms the extractor element is cured to a solid state, as indicated in FIG. 2E. For example, the curing can be performed by applying (e.g., through the mold 242) heat or UV light 255 or both (successively or concurrently). The curing of the extractor element molded at 240 results in a cured extractor element 130, to form a light-emitting device.

The cured extractor element 130 has an index of refraction n_{1c} that is substantially the same or larger than the index of refraction nₚ of the scattering element 120. If a hard optical-quality surface 244 was disposed in the cavity 246 at 240, the hard optical-quality surface 244 can form a part of the cured extractor element 130, for example, to form a protective shell around the exit surface 135 of the cured extractor element 130. In this case, the hard optical-quality surface 244 has an index of refraction that is substantially the same or larger than the index of refraction n_{1c} of the bulk of the cured extractor element 130. In some implementations, a hardness of the hard optical-quality surface 244 can be larger than a hardness of the bulk of the extractor element 130, e.g., 1.05×, 1.10×, 1.50×, 2×, 10× harder.

The mold 242 can be decoupled from the light-emitting device prior to, during or after curing, at 250, the extractor element 130. In some implementations, post-curing can be performed to further harden the extractor element 130. In some embodiments, a release agent is used to facilitate removal of the extractor element from the mold. In some implementations, it is desirable to fabricate extractor elements that have shapes extending beyond hemispheres, such that a pattern of light output from the light-emitting devices subtends more than 180°. In such cases, the mold 242 can include two or more pieces that are separated after cure.

In some implementations, the extractor element 130 can be formed using an injection molding process. The base substrate 105 with the scattering element 120 can be brought together with the mold 242 and the fluid 130-u can be pressure injected into the mold 242 through inlet channels (not shown in FIG. 2D.) A vacuum can be created to extract the air from the cavity 246. The pressure injected fluid 130-u can be cured as described herein at 250 and the mold 242 is then separated from the light-emitting device.

In some implementations, the hard optical-quality surface 244 can be coupled to the base substrate (e.g., by using silicone as adhesive) to form an enclosure for the fluid 130-u, which can remain in a liquid or gel state. In such configurations, the fluid 130-u has an index of refraction n₁ᵤ that is substantially the same as or smaller than the index of refraction of the hard optical-quality surface 244, but larger than the index of refraction nₚ of the scattering element 120. In this case, a hardness of the hard optical-quality surface 244 can be larger than a hardness of the bulk of the extractor element 130, as the latter is in gel state.

Though the example fabrication process has been described with respect to a light-emitting device including a single light-emitting element, the process described herein can also be implemented for an array of light-emitting elements that can be separated into individual light-emitting devices after completing the fabrication process, for example. In some implementations, a light-emitting device 100 can include multiple light-emitting elements. In some implementations, a light-emitting device 100 can include multiple scattering elements.

1. A light-emitting device, comprising:
a base substrate having a base surface;
a light-emitting element (LEE) configured to emit light, the LEE being disposed on the base surface;
a first optical element having a first surface spaced apart from the LEE and positioned to receive light from the LEE, the first optical element comprising scattering centers arranged to scatter light from the LEE, wherein the first optical element has a non-hemispherical shape;
a second optical element having an exit surface, the second optical element being transparent and in contact with the first optical element, there being an optical interface between the first and second optical elements at the place of contact, the optical interface being opposite the first surface of the first optical element, the second optical element being arranged to receive at least a portion of the light through the optical interface; and
a transparent shell having an inner surface and an opposing outer surface, the inner surface being in contact with the exit surface of the second optical element, wherein:
a medium adjacent to the first surface of the first optical element having a refractive index n₀,
the first optical element comprises a material having a refractive index n₁, where n₀<n₁,
the second optical element comprises a material having a refractive index n₂, where n₀<n₂, and
the transparent shell comprises a material having a refractive index n₃, where n₃≧n₂.

2. The light-emitting device of claim 1, wherein the first optical element comprises phosphor.

3. The light-emitting device of claim 1, wherein a hardness of the transparent shell is larger than a hardness of the second optical element.

4. The light-emitting device of claim 1, wherein the material of the transparent shell is solid and the material of the second optical element is liquid or gel.

5. The light-emitting device of claim 1, further comprising a reflective layer disposed on the base surface of the base substrate.

6. The light-emitting device of claim 1, wherein the outer surface of the transparent shell is a transparent surface that is shaped such that an angle of incidence on the outer surface of the light provided by the first optical element that directly impinges on the outer surface is less than a critical angle for total internal reflection.

7. The light-emitting device of claim 1, wherein the outer surface of the transparent shell is a transparent surface that is shaped such that an angle of incidence on the outer surface of the light provided by the first optical element that directly impinges on the outer surface is less than a Brewster angle.

8. A method for forming a light-emitting device comprising:
providing a light-emitting element (LEE) on a base surface of a base substrate;
coupling a first optical element with the base surface of the base substrate, the first optical element having a first surface facing the LEE and a second surface opposing the first surface, the first surface being spaced apart from the LEE, the first optical element comprising a material having a first refractive index n₁, and a medium adjacent to the first surface of the first optical element having a refractive index n₀<n₁;
disposing the first optical element in a curable or settable fluid so that the fluid conforms to the second surface; and
curing or setting the fluid to form a second optical element adjacent the second surface of the first optical element, the second optical element having a refractive index n₂>n₀.

9. The method of claim 8, wherein the second optical element comprises a molded transparent layer.

10. The method of claim 8, wherein the second surface of the first optical element has a non-hemispherical shape.

11. The method of claim 8, wherein the fluid is provided in a transparent shell.

12. The method of claim 11, wherein the transparent shell has an outer surface that corresponds to the exit surface of the second optical element.

13. The method of claim 11, wherein the transparent shell remains with the light-emitting device and an outer surface of the transparent shell is a transparent surface that is shaped such that an angle of incidence on the outer surface of the light provided by the second optical element that directly impinges on the outer surface is less than a critical angle for total internal reflection.

14. The method of claim 8, wherein said curing or setting comprises exposing the fluid to UV radiation.

15. The method of claim 8, wherein said curing or setting comprises heating the fluid.

16. The method of claim 8, further comprising providing a reflective layer on the base surface, the reflective layer being configured to diffusely or specularly reflect light.

17. The method of claim 8, wherein the exit surface of the second optical element is a transparent surface that is shaped such that an angle of incidence on the exit surface of the light provided by the first optical element that directly impinges on the exit surface is less than a critical angle for total internal reflection.

18. The method of claim 8, wherein the exit surface of the second optical element is a transparent surface that is shaped such that an angle of incidence on the exit surface of the light provided by the first optical element that directly impinges on the exit surface is less than a Brewster angle.
